(19) United States
(12) Patent Application Publication
(10) Pub. No.: US 2025/0152450 A1
(43) Pub. Date: May 15, 2025

(54) GRAVITY-BASED THERAPY CHAIR

(71) Applicants: Natalia Gallo, Lincoln Park, NJ (US); Mark Annett, Livingston, NJ (US); John Sinisi, WARMINSTER, PA (US); Jesse Sinisi, WARMINSTER, PA (US)

(72) Inventors: Natalia Gallo, Lincoln Park, NJ (US); Mark Annett, Livingston, NJ (US); John Sinisi, WARMINSTER, PA (US); Jesse Sinisi, WARMINSTER, PA (US)

(73) Assignee: Natalia Gallo, Lincoln Park, NJ (US)

(21) Appl. No.: 18/946,653

(22) Filed: Nov. 13, 2024

Related U.S. Application Data
(60) Provisional application No. 63/548,227, filed on Nov. 13, 2023.

(51) Int. Cl. A61H 1/02

(52) U.S. Cl. CPC A61H 1/0292; A61H 2201/0149; A61H 2201/1623; A61H 2201/1671; A61H 2203/0431; A61H 2205/081

(57) ABSTRACT

A back stretching apparatus comprising: a seat; a shoulder/head rest; and back section, which is rotatably connected between the seat and shoulder/head rest, wherein the seat is configured to at least rotate backwards and to outwardly travel away from the shoulder/head rest, and wherein the shoulder/head rest is angled with respect to the seat and configured to advance at least linearly along this angle in tandem with the outward movement of the seat is described along with methods of its use. The methods comprise performing the steps of a user sitting on the seat of the apparatus, tilting the seat backwards to a tilted position, moving the seat outward when in this tilted position; and advancing the shoulder/head rest in tandem with the moving of the seat.

### FIELD OF INVENTION

Gravity-Based Therapeutic Stretching Systems and Methods.

### BACKGROUND

Back pain is the sixth most costly medical condition in the US, with $100B+ being spent annually and 8% of all adults experience persistent or chronic back pain (16 M people).

Gravity-based stretching is one of the best ways to provide therapy as it helps alleviate spinal compression by using the body's own weight to create space between the vertebrae. This method is advantageous over other means because by utilizing the body's natural weight, it ensures a consistent and gentle decompression, and reduces the risk of overstretching or injury that can occur with manual or machine-assisted methods. However, hanging upside down, a common gravity-based stretching technique, can pose risks. For example, with heart disease, this position can increase blood pressure and strain the cardiovascular system. Additionally, those with glaucoma may experience increased intraocular pressure, potentially worsening the condition. For those with debilitating back pain, it is currently not physically possible for them to get into a position that allows for gravity-based stretching on their own.

Therefore, there continues to be a need for gravity-based stretching, where anyone that can walk up to a chair and sit down can get gravity-based stretching, without having to be turned upside down.

### BRIEF DESCRIPTION OF DRAWINGS

FIG. 1 shows, in simplified form, an anti-gravity therapy chair, which has a leg holder, a leg rest, a seat, a back section, and a head/shoulder rest, where the seat is in the horizontal seat position;

FIG. 1A-B shows, in simplified form, an anti-gravity therapy chair, with alternative leg rests;

FIG. 2 shows, in simplified form, a user sitting on the anti-gravity therapy chair, with the leg-holder still in the loading position;

FIG. 3 shows, in simplified form, a user sitting on the anti-gravity therapy chair rotated backwards from the horizontal seat position and the leg-holder in the leg constraining position;

FIG. 4 shows, in simplified form, a user in the process of stretching while using the anti-gravity therapy chair;

FIG. 5 shows, in simplified form, the anti-gravity chair of FIG. 4 without a user and with the optional mechanical cover removed;

FIG. 6 shows, in simplified form, the anti-gravity chair of FIG. 5 with the near frame removed;

FIG. 7, shows in simplified form, an enlarged view of the components of the seat angle mechanical stop attached to the angle adjustment support;

FIG. 8, shows in simplified form, the anti-gravity chair of FIG. 6 but with the an electro mechanically adjustable length back section;

FIG. 9, shows in simplified form, the anti-gravity chair of FIG. 6 with several components removed; and

FIG. 10, shows in simplified form, steps associated with a method of stretching a user's back.

### SUMMARY OF THE INVENTION

In order to overcome the deficiencies in the prior art, systems and methods are described herein.

One aspect of the claimed invention involves a back stretching apparatus comprising: a seat; a shoulder/head rest; and back section, which is rotatably connected between the seat and shoulder/head rest, wherein the seat is configured to at least rotate backwards and to outwardly travel away from the shoulder/head rest, and wherein the shoulder/head rest is angled with respect to the seat and configured to advance at least linearly along this angle in tandem with the outward movement of the seat.

Another aspect of the claimed invention involves a method of stretching a user's back using an apparatus comprising a seat; configured to have a user sit upon it, a shoulder/head rest, and a back section rotatably connected between the seat and shoulder/head rest configured to perform the following steps: tilting the seat backwards to a tilted position, moving the seat outward when in this tilted position; and advancing the shoulder/head rest in tandem with the moving of the seat.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages or features are mutually exclusive or contradictory, in that they cannot be simultaneously present in a single embodiment. Similarly, some advantages are applicable to one aspect of the invention, and inapplicable to others. Thus, the elaborated features and advantages should not be considered dispositive in determining equivalence. Additional features and advantages of the invention will become apparent in the following description, from the drawings, and from the claims.

### DETAILED DESCRIPTION

As described in the background section, there continues to be a need for gravity-based stretching, where anyone that can walk up to a chair and sit down can get gravity-based stretching without having to be turned upside down.

We will begin by walking through a broad overview of the system in methods during use before turning our attention to the details of the representative embodiments.

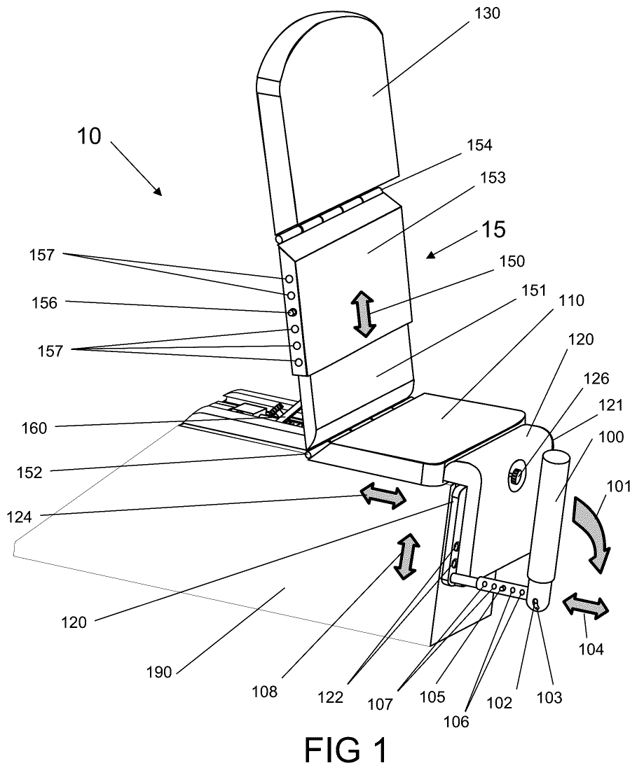

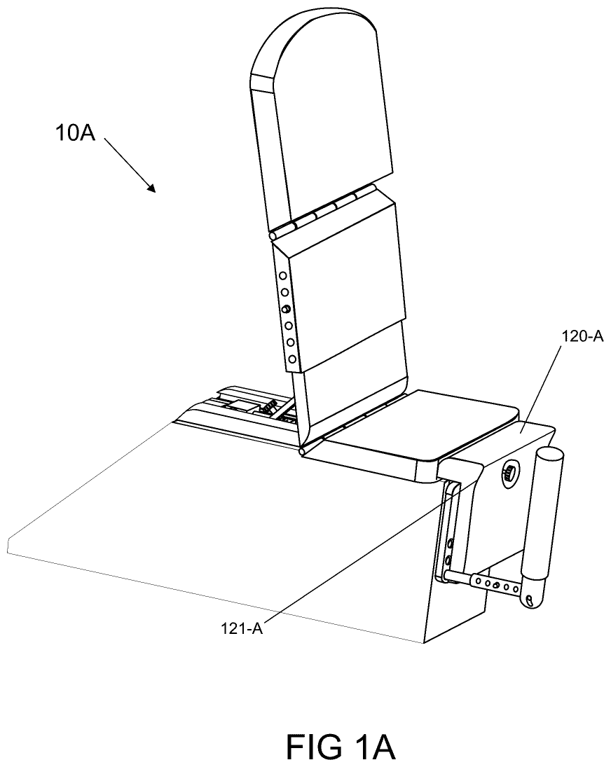

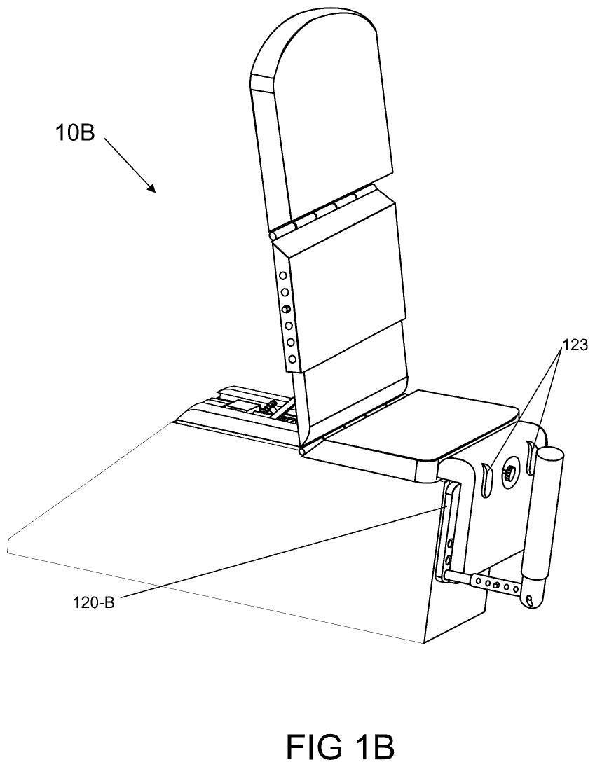

FIG. 1 shows, in simplified form, an anti-gravity therapy chair 10, which has a leg-holder 100, a leg rest 120, a seat 110, a back section 15, and a shoulder/headrest 130, where the seat is in the horizontal seat position. In this representative embodiment, the optional leg-holder 100 is shown as a rotatable bar, which is currently in the loading position and is configured to have a leg holder rotation 101 that allows the leg-holder 100 to rotate into a leg constraining position (not shown). In this particular configuration, the leg holder 100 is represented as being constrained to rotate from the loading position to the constraining position by a pin 103 in a channel 102, such that the rotation is configured to be slightly more than 90 degrees. Thus, in the current position the leg-holder 100 is falling open (in the opposite direction of the leg holder rotation 101) due to gravity. Then, once the leg-holder 100 has rotated in the direction of the leg holder rotation 101, then it will again fall due to gravity but this time in the direction of the leg holder rotation 101 and into to the constraining position, configured to be parallel to the ground, also not shown.

It is worth noting that in this embodiment, the leg-holder 100 is not configured to be locked in position. Non-locking has been observed to be advantageous (1) in the event that a user wants to do an emergency exit from the anti-gravity therapy chair 10 (e.g. a power failure where no back up power has been supplied or other condition requiring an urgent exit); and (2) because in general full constraint with respect to locking a user's legs to the anti-gravity therapy chair 10 is unnecessary to achieve therapeutic gravity-based stretching, since the user is not being turned fully upside down.

Often all that is needed is slight contact against the user's legs to maintain the user's legs at a desired angle (typically 90 degrees/right angle) with respect to the seat in order to maintain the desired position for therapeutic stretching. Alternatively, the user can also typically bodily supply their own force to maintain the desired position, which is why the leg holder 100 was introduced as being optional. However, the user needing to supply a force to bodily maintain position is disadvantageous to stretching.

On the other hand, if locking of the leg holder 100 is desired, then the pin 103 and channel 102 could be replaced with a ball detent configuration or other mechanical locking mechanism. Further, while full constraint of the user's legs has not been observed to be necessary, the leg-holder 100 is also anticipated to be configured as locking straps and/or constraining cuffs that lock the user's legs in a particular configuration.

Note: while the desired angle with respect to the seat is typically 90 degrees variations+/−20 degrees may be appropriate: (1) where having the persons legs more curled underneath the user will potentially cause more stretching to occur but (2) having the legs less curled can reduce leg pain, particularly under the knees. The importance being not the particular constraint used but that it is configured to facilitate maintaining the user's legs in a fixed position to allow therapeutic gravity-based stretching to occur. Additionally, other angles including powered rotation to be at any angle up to and including horizontal with the seat are also anticipated.

Further, to accommodate various users, the leg-holder 100 is shown with two adjustments: a leg-holder depth adjustment 104, which is represented as accomplished by compression pin 105 and adjustment holes 106; and leg-holder height adjustment holes 122, which in this particular embodiment a part of leg rest 120. For many users, adjustment will be unnecessary, as exact positioning is typically not required, though it can be beneficial to maximize user comfort. In addition to the represented fixed positioning of the leg-holder depth adjustment 104 in this embodiment, spring loaded adjustment is also anticipated, such that the leg-holder 100 is configured to constantly be pulling the user's legs against the leg rest 120. Again, the importance being not the particular constraint used but that it is configured to facilitate maintaining the user in position to allow therapeutic gravity-based stretching to occur.

The leg rest 120 is represented to have at least an adjustable seat depth 124 to accommodate various sized users; however a fixed seat depth, without a leg rest is an alternative configuration. Unlike, leg holder depth adjustment 104, the adjustable seat depth 124 is much more critical to maintaining the user in the desired therapeutic gravity-based stretching position. As such, the leg rest 120 is represented as being infinitely adjustable using a seat depth adjustment mechanism 126. The recommended procedure for adjusting the seat depth is to have the user sit fully against the back section 15 and then move the leg rest 120 until the user's legs make contact the full length of the leg rest 120. Note: the leg rest is represented as an upside down “L,” with a rounded top 121 for under the user's knee. The extended downward portion is shown because it is advantageous for determining proper seat depth adjustment. However, the extended portion is in general not necessary to maintain the user in position to allow therapeutic gravity-based stretching because the user's legs will tend to pull away from the extended portion of the leg rest 120. Thus, in general, you could get away with a smaller padded leg rest just associated with the user's knees. However, the extended portion also serves a secondary safety purpose of preventing the user from folding their legs underneath and possibly into the apparatus during use. Further, while the leg rest is represented as an upside down “L,” with a rounded edge 121 for under the user's knee, more contoured designed of leg rests are anticipated, as exemplified in FIG. 1A-B.

FIG. 1A shows, in simplified form, an anti-gravity therapy chair 10-A with alternative leg rest 120-A, where the leg rest is flatter at the top and has a backwards curvature 121A configured to follow the contour of the user's calf.

FIG. 1B shows, in simplified form, an anti-gravity therapy chair 10-B with alternative leg rest 120-B, which has two recess 123 designed to remove the point of contact with the back of the knee. This recess can be particularly useful the higher the person is raised as the edge of the seat may put pressure on the sciatic nerve, more specifically, one of its branches, the tibial nerve, which runs under the back of the knee and can get compressed if a chair edge presses against it. When prolonged pressure is applied to this area (also called the popliteal fossa, which is a small hollow at the back of the knee) it can lead to nerve compression or irritation, resulting in pain, tingling, or even numbness along the lower leg. Note: while the two recess 123 are shown as just being a recess under the knee, configurations where the recess runs the entire length of the leg, or some portion thereof, are also anticipated.

Returning to FIG. 1, the back section, which could be fixed in length, is shown as having a back length adjustment 150 due to the lower back 151 and the upper back 153 being able to telescope. The lower back 151 is represented as being rotatably connected 152 to the seat 110 and the upper back 153 is represented as being rotatably connected 154 to the shoulder/headrest 120.

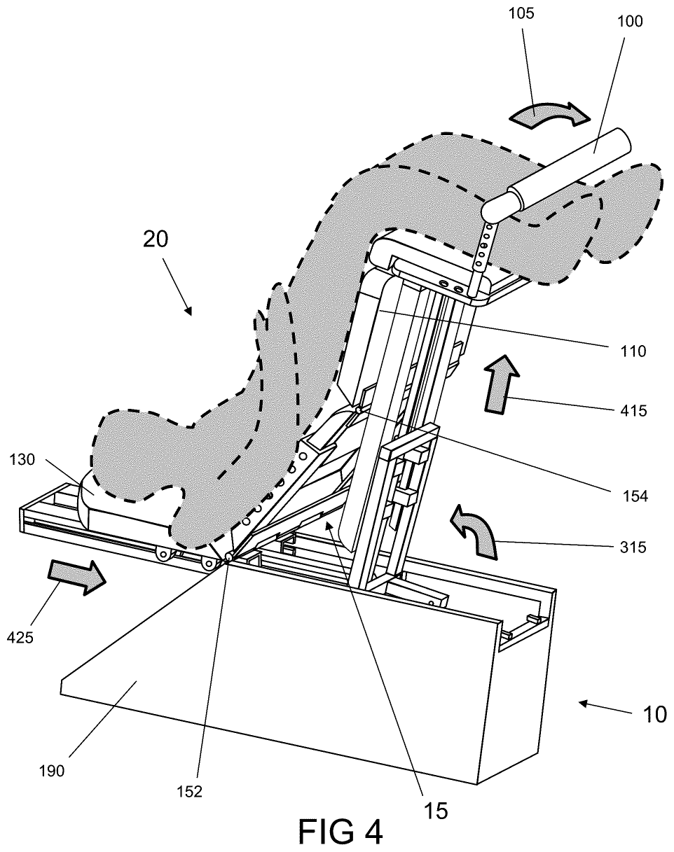

While in some embodiments the length of the back is unconstrained, in this particular embodiment the changes in back length (also referred to as back length) are represented as accomplished by compression pin 156 and adjustment holes 157. Here, while not required to be adjusted as precisely as seat depth, back height is still relatively important. The recommended procedure is (after adjusting for seat depth) the user should raise their arms out to their sides and the back length adjustment 150 should be made such that the bottom of the shoulder/headrest 120 is at the level of the user's armpit. The purpose of this positioning is to ensure that when the users in a stretching position (see FIG. 4) a significant portion of the user's body weight, typically 15% or more, will be supported by the user's shoulders rather than all of the body weight being supported by the user's legs. The latter situation can end up being particularly painful, especially under the user's knee.

Note: the term shoulder/head rest will be used throughout this document. However, a head rest, without a shoulder rest; and a shoulder rest, without a head rest, are both anticipated:
a) with respect to the former, the majority of the weight that would have been born by the user's shoulders will now be transferred to the user's head and neck, which can cause pain and could potentially result in neck injury, and
b) with respect to the latter, where there is no head rest the user will not only have to support their head themselves, which will mean that it will be harder for them to relax their back muscles and obtain therapeutic stretching but care must be taken that the user's head (and hair) will not strike and/or become entangled in the system.

Thus the term shoulder/head rest is inclusive a head rest, without a shoulder rest; and a shoulder rest, without a head rest, where the deficiencies in a) and b) have been overcome. For example, with respect to a) a shoulder support is incorporated into the back section or with respect to b) one or more of the following the shoulder support contains a neck support; the head rest is a separate component either a part of the system or a separate apparatus worn by the uses such as a neck brace or neck pillow.

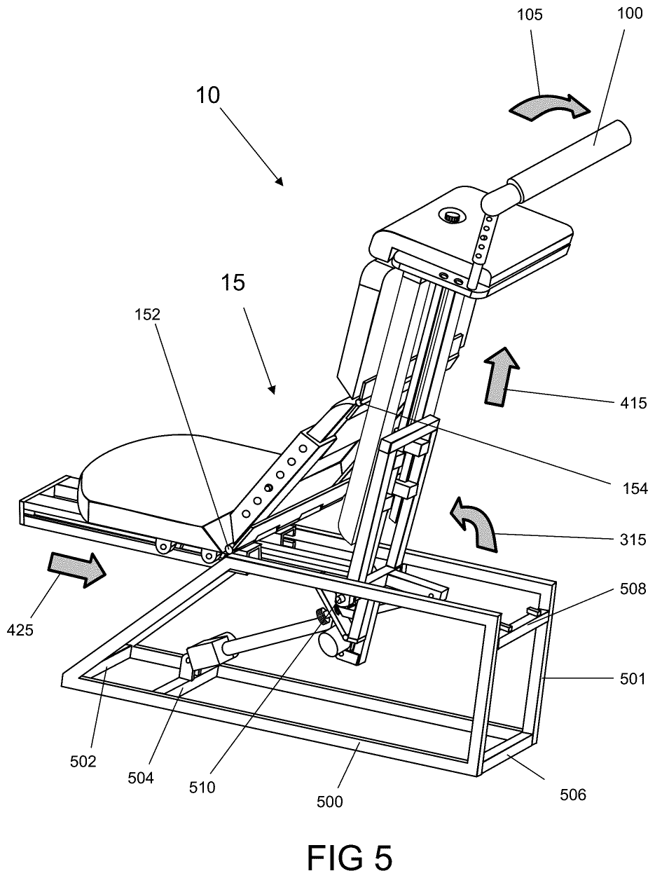

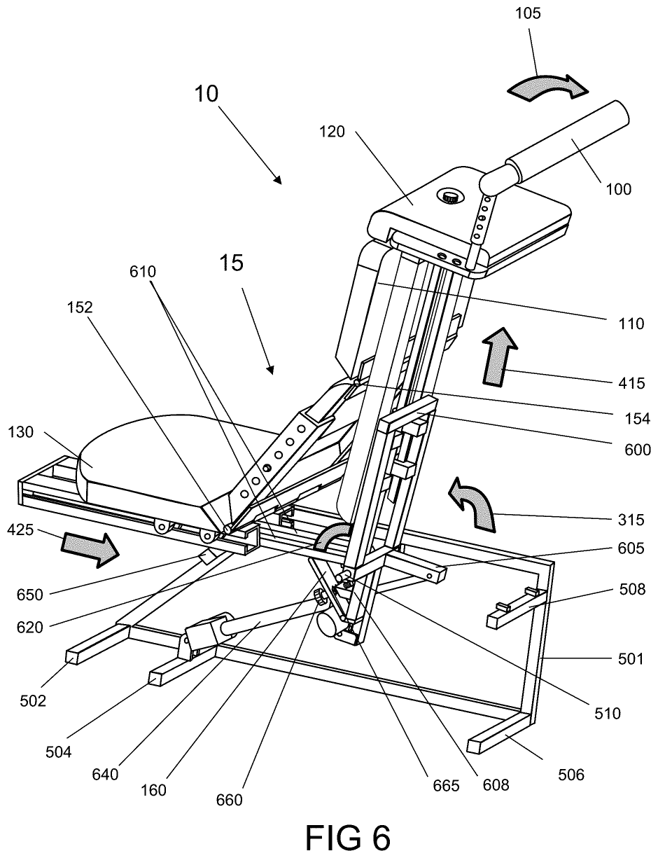

Additionally, shown in FIG. 1 is a seat angle mechanical stop 160 (which will be discussed in more detail in FIG. 6) and the optional mechanical covering 190 (which will be removed beginning with FIG. 5).

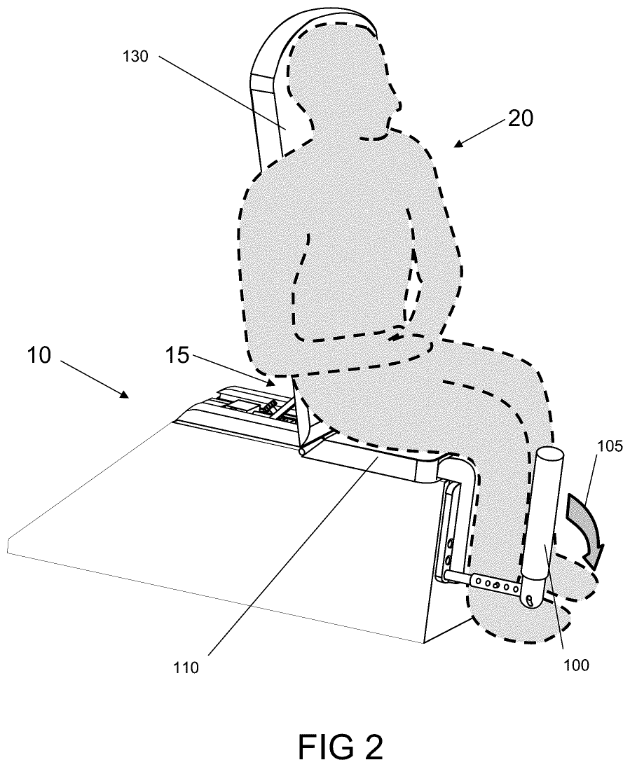

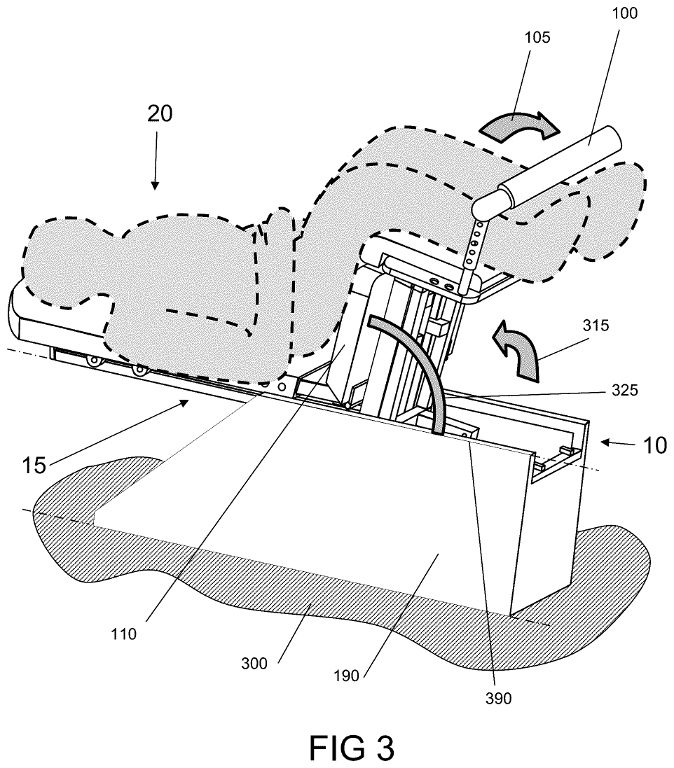

FIG. 2 shows, in simplified form, a user 20, shaded and represented with dashed lines, sitting on the anti-gravity therapy chair 10, with the leg-holder 100 still in the loading position. The user is leaning against back section 15 and the shoulder/headrest 130 and is sitting on seat 110. The leg holder 100 is configured to maintain the user's legs at fixed angle with respect to the seat 110 during therapeutic stretching which will become clearer as we move through FIGS. 3-4.

FIG. 3 shows, in simplified form, a user 20 sitting on the anti-gravity therapy chair 10 rotated backwards from the horizontal seat position and the leg-holder 100 in the leg constraining position, by being rotated in the direction of the leg holder rotation 101. The anti-gravity therapy chair 10 is configured to rotate backwards in a seat rotation 315 direction and produce a seat-tilt angle 325 with respect to a theoretical horizontal position to the ground. Note: for the purposes of visualization the seat tilt angle is drawn with respect to the top edge 390 of the optional mechanical covering 190, wherein the top edge 390 is represented as parallel to, and thus a surrogate for, the ground 300. It should be further noted that other than for the purpose of visualizing seat-tilt angle 325 in FIG. 3, there is no requirement that optional mechanical covering 190 exist nor that it's top edge 390 be parallel to the ground.

While therapeutic gravity-based stretching can occur at an intermediate position, in this particular embodiment, the shoulder/headrest 130 is configured to fall backwards at a fixed angle to the seat 110, until the shoulder/headrest 130 hits an optional shoulder/head rest mechanical stop, not visible in the present drawing, but the shoulder/head rest mechanical stop 650 can be seen in FIG. 6, which creates a limit for the shoulder/head rest angle 620, also visible in FIG. 6.

Returning to FIG. 3, once the shoulder/headrest 130 hits the optional mechanical stop (not shown), then the shoulder/headrest 130 is configured to rotate backwards no further. In this particular embodiment the anti-gravity chair 10 is represented as having constrained the shoulder/headrest 130 from rotating past the point of being horizontal to the ground 300. Thus, even if the seat 110 continues to rotate backwards in the direction of the seat rotation 315, the shoulder/headrest 130 will remain in a fixed relationship to the ground 300 and not the seat 110. Fortuitously, in this represented configuration the user will not experience the being turned upside down feeling during the backwards rotation phase. [Note: in practice since most users sleep with a pillow, many users are actually not comfortable with being fully horizontal. Thus, a mechanical stop set 10 to 20 degrees above fully horizontal (or use of a pillow) will often increase the user's comfort.]

Importantly, the shoulder/headrest 130 will remain in a fixed relationship to the ground 300 until the seat is rotated in the opposite direction of the seat rotation 315 and the original fixed angle between the shoulder/headrest 130 and the seat 110 is once again achieved, at which time they will once again rotate together. [Note: the mechanics of this relationship will become clearer once we delve into the details of this embodiment.]

Having delved into seat rotation, we will now describe therapeutic stretching.

FIG. 4 shows, in simplified form, a user 20 in the process of stretching while using the anti-gravity therapy chair 10. In order to get anti-gravity stretching the seat 110 is configured to not just have a seat rotation 315 but to also have a seat outward travel 415 (away from the shoulder/headrest). As previously described, the back section 15 is configured to be linked to both the shoulder/headrest 130 (through the shoulder linkage 152, represented as a hinge), and to the seat 110 (through the seat linkage 154, also represented as a hinge). Because of these two linkages, then as long as the length of the back section 15 remains fixed, then as the seat 110 travels outward in the seat travel direction 415, the shoulder/headrest 130 is pulled downward in a shoulder collapsing direction 425 (which is at least linearly along the path of the shoulder/head rest angle 620, see FIG. 6), thus the two move in tandem.

Returning to FIG. 4, if the seat 110 travels in the opposite direction, then the shoulder/headrest 130 travels in the opposite direction as well. It should be further noted that the system works the same whether it was the seat 110 that was pushing/pulling or the shoulder/headrest 130, the importance being that the two are configured to move in tandem to one another when the length of back section 15 remains fixed.

Having described the system broadly in terms of usage, we will now turn our attention to the details of the representative embodiments.

FIG. 5 shows, in simplified form, the anti-gravity chair 10 of FIG. 4 without a user and with the optional mechanical cover removed. With the cover removed, FIG. 5 discloses a frame comprising: a near frame 500, a far frame 501, and several cross braces 502, 504, 506, 508. Spanning between the frames 500, 501 is a seat axis of rotation 510. Note: the frame is shown as comprised of constituent parts and being of a right-angled trapezoid configuration. The particular configuration is not important, as long as it is configured to safely allow the anti-gravity chair to operate through its range of motion with a user on board.

FIG. 6 shows, in simplified form, the anti-gravity chair 10 of FIG. 5 with the near frame 500 removed. With the near frame removed, additional components are more easily identified, and the functions described with respect to FIG. 3 can now be more fully explained, particularly since the previously non-visible shoulder/head rest mechanical stop 650 is now visible.

Specifically, in FIG. 6 we see a seat frame 600, which is represented as a rectangular frame in shape (and has a seat frame arm 605 and an angle adjustment support 608), and a back frame 610, which is partially visible underneath the shoulder/headrest 130. While the seat frame 600 and the back frame 610 could be in a fixed relationship, in this embodiment, they are rotatably connected together (note: the rotatable connection is not visible in this drawing) and there is a shoulder/head rest angle 620 relationship between them, typically set to between 90 and 110 degrees, though greater/lesser angles may be desirable (and is additional to the previously mentioned seat-tilt angle 325 of FIG. 3).

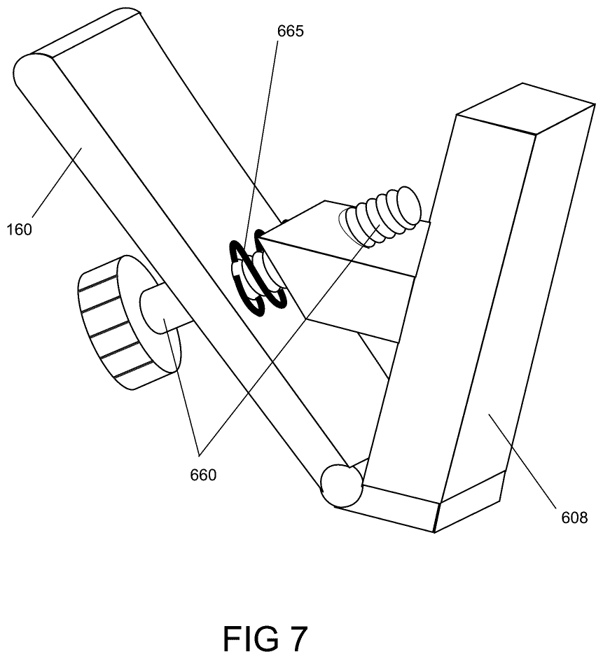

In FIG. 6, the shoulder/head rest angle 620, which in this embodiment is configured to be constantly falling open, is adjusted/set by the seat angle mechanical stop 160, which is represented as a hinged plate, and is pushed against a threaded adjustment knob 660 by a spring 665, which are actually easier to see in FIG. 7. Returning back to FIG. 6, while mechanical stops are known in the art, what is important about this configuration is that it allows the shoulder/head rest angle 620 to decrease but not increase beyond a maximum angle set by the seat angle mechanical stop 160. Importantly, this configuration allows for a very therapeutic rocking motion to be produced. Specifically, by continuing to rotate the seat 110 in the direction of the seat rotation 315 a shoulder/head rest angle 620 of less than 90 degrees can be achieved, which allows for some slight flexion, the bending forward of user's spine. Then, when the seat 110 is rotated in the opposite direction of seat rotation 315 it creates stretching again. This gentle rocking back and forth is very therapeutic in helping the users back muscles to relax. Note: while gravity and simple mechanical stopping mechanisms 160, 650 are represented in this embodiment the shoulder/head rest angle 620 could also be electro mechanically (or pneumatically) driven by making one or more of the mechanical stopping mechanisms 160, 650 electromechanically mechanically (or pneumatically) controlled. The importance being not the particular mechanism utilized but that a shoulder/head rest angle 620 of less than 90 degrees is able to be achieved.

As previously stated, the seat rotation 315 of the seat is about the seat central axis 510. Seat rotation 315 is driven by a seat rotation actuator 640, represented as a linear actuator, which in this embodiment is represented as rotatably connected to frame cross bar 504 and seat frame arm 605. It is worth noting that, in this particular embodiment, at the start of seat rotation 315 (e.g., the seat frame is in contact with the crossbar 508), the seat rotation actuator 640 is initially pushing against the seat frame arm 605 to cause rotation. However, at some point during the rotation, the center of mass will shift past the seat central axis 510 and the seat rotation actuator 640 will be restraining the seat from falling and thus it will be pulling against the seat frame arm 605 and this change in forces needs to be planned for. Note a linear actuator is only one of many options for generating rotation. Other options include cable or gear driven mechanisms and other both linear and nonlinear drive mechanisms. The importance being not the particular mechanism selected but that it is capable of rotating a user possibly weighing 300 or more pounds through the desired range of motion both in the seat rotation 315 direction and then returning them back to the horizontal seat position.

In FIG. 6 we can now also partially see the previously unidentified optional shoulder/head rest mechanical stop 650, which is represented as a fixed crossbar. (Note: an adjustable position mechanical stop is also anticipated.) As previously discussed, once the shoulder/headrest 130 (or more precisely once the back frame 610) hits the optional shoulder/head rest mechanical stop 650, then even if the seat 110 continues to rotate backwards in the direction of the seat rotation 315, then the shoulder/headrest 130 will remain in a fixed relationship to the ground by resting on shoulder/head rest mechanical stop 650, but the shoulder/head rest angle 620 will now begin to decrease. Thus, the shoulder/headrest 130 will remain resting on the shoulder/head rest mechanical stop 650 until the seat is rotated in the opposite direction of the seat rotation 315. Then, once the originally set the shoulder/head rest angle 620 (controlled by the seat angle mechanical stop 160) between the shoulder/headrest 130 and the seat 110 is achieved, then they will once again rotate together.

FIG. 7, shows in simplified form, an enlarged view of the components of the seat angle mechanical stop 160 attached to the angle adjustment support 608.

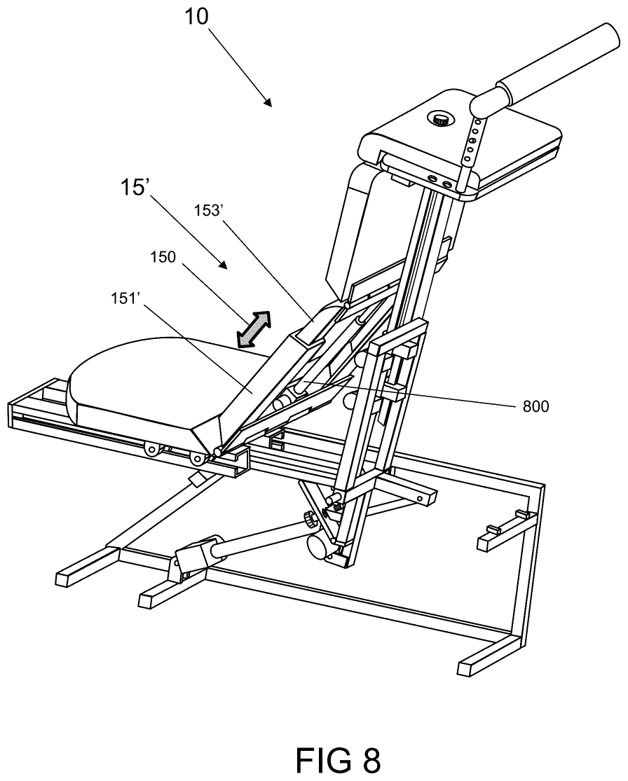

FIG. 8, shows in simplified form, the anti-gravity chair 10 of FIG. 6 but with the an electro mechanically adjustable length back section 15′, comprising a lower back 151′ and a upper back 154′ and a powered back length adjuster 800. Specifically, the back length adjustment 150 comprises the compression pin 156 and adjustment holes 157, as discussed in FIG. 1, has been replaced in FIG. 8 by the powered back length adjuster 800, represented as a linear actuator.

Powered back length adjustment is preferable to manual adjustment because it not only allows the back length to be adjusted during setup, but it also allows for back lengthening during use. For example, the length of most user's torsos can be accommodated a back lengthen adjustment 150 that varies by 4-6 inches. However, once reclined and elevated the user's back will naturally lengthen due to gravity and powered adjustment allows for this expansion to be accommodated. Additionally, often an additional powered expansion of the back length by 1 to 2 inches (or more) during use can be very therapeutic and powered expansion allows this to easily happen and it can be something that is programmed to automatically occur, be controlled by the user, or in an attending therapist. Other options for back length adjustment 150 include spring loading the back section such that it is always trying to move towards either the minimum or maximum length, where the former maximizes load bearing on the user's shoulders and the latter stretching of the user's back.

We will now return our attention to describing a few more features of the embodiment last described in FIG. 6 by continuing to remove features so that others can be explained.

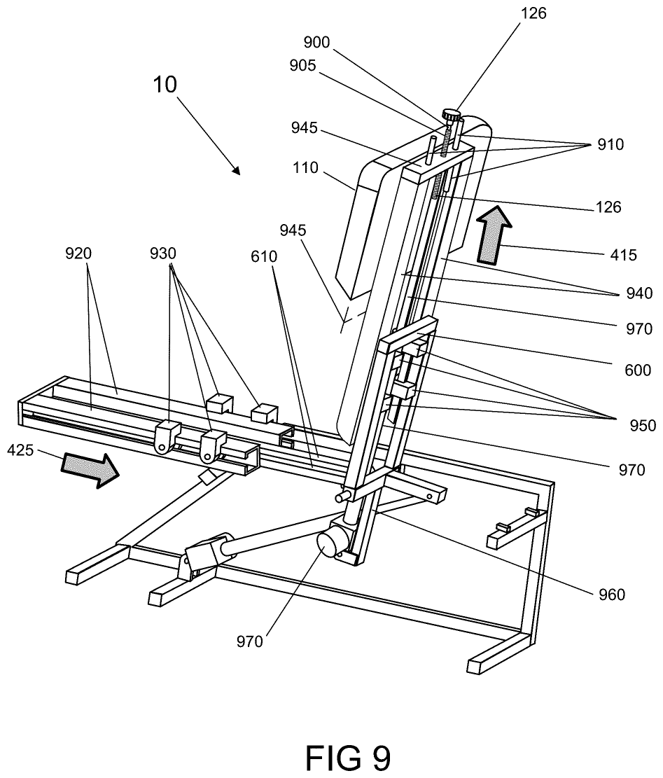

FIG. 9, shows in simplified form, the anti-gravity chair 10 of FIG. 6 with several components removed. Specifically, the following components visible in FIG. 6 have been removed: the leg-holder 100, leg rest 120, the shoulder/headrest 130, back section 15 (including its two rotatable connections 152, 154), and seat angle mechanical stop 160 (including the seat frame's 600 angle adjustment support 608).

Thus, with these components removed, in FIG. 9 we can see that the seat depth adjustment mechanism 126 has a recess 900, which is configured to restrain leg rest 120 (see FIG. 6) such that the two move together in the direction of the seat outward travel 415. Specifically, in FIG. 9, we see that the seat depth adjustment mechanism 126 is threaded 905 into a seat track end cap 945, which allows for infinite adjustment; however fixed increment adjustments are also anticipated. Additionally, we see in FIG. 9 one or more anti-rotation post 910, which are configured to be connected to the leg rest 120 (see FIG. 6) and to run through the seat track end cap 945, which in so doing are configured to stop the leg rest 120 from rotating.

With respect to FIG. 4, we described how as the seat 110 travels outward in the seat travel direction 415, the shoulder/headrest 130 is pulled downward in the shoulder collapsing direction 425. In FIG. 9, we can now see the underlying mechanics, which allows this to happen.

In both cases that travel is represented as being accomplished via a track 920, 940 and a track rider 930, 950 configuration. In the case of the shoulder/headrest 130 (see FIG. 4) the tracks 920 in FIG. 9 are outward facing and are constrained to the back frame 610 and the track riders 930, which are represented as two per track 920, are what travel. However, in the case of the seat 110 the opposite is represented. Specifically, in FIG. 9, the track riders 950, which are also represented as two per track 940, are represented as constrained to the seat frame 600 and the tracks 940, which are inward facing and attached to the seat 110 are what travel.

Note: whether either set of tracks 920, 940 are inward/outward facing is a design choice. However, inward facing tracks 940 are particularly advantageous with respect to the seat 110 for safety reasons as a user may often try and hold onto the bottom of the seat 110 for stability and in doing so maybe able to get their fingers inside an outward facing track. If the track associated with the seat 110 where outward facing then a seat overhang 945 of at least four inches is recommended. While the seat overhang 945 can be less if the track is inward facing one should still take precautions to make sure that the user's fingers will not reach the seat frame 600, if the user would likely be reaching around the seat track as well.

Both sets of tracks 920, 940 are represented as dual tracks with two track riders 930, 950 per track 920, 940 to allow for more stability over a single track and track rider configuration, which is also anticipated. However, track and track rider are one of many options to create the desired travel. A non-exhaustive list of configurations comprises telescoping and thread driven, which had been previously described as well as other systems known in the art such a rack and pinion, mechanical linkage (e.g. scissors systems) . . . etc. However, unlike these other options, which are typically linear, track and track rider systems can incorporate nonlinear/curved track that can be used to facilitate flexion (e.g. as the seat travels upward, it also curves toward the user's back) or hyper extension (e.g. as the seat travels upward, it also curves away from the user's back) and are also anticipated. The importance being not the particular mechanism used to produce the travel but that it is configured to produce the desired travel and desired stretching of the user's back, see FIG. 4.

It is also worth noting that, in FIG. 9, all of the motion with respect to the tracks 920, 940 is produced by a single seat drive mechanism 970, represented as a linear actuator, that extends from a previously been described component of seat frame 600, which is a seat drive extension 960, all the way to the seat track end cap 945.

Throughout this document any of the one or more of the electromechanical drive mechanisms (or their equivalent) are anticipated to be controlled directly via position controls (not shown), remotely actuated via a remote control (not shown), or programmatically via a processor (not shown) configured to run computer code and to control one or more of the electromechanical drive mechanisms (or their equivalent). Such control is anticipated to controlled by one or more of the user, a therapist treating the user, or via the processor.

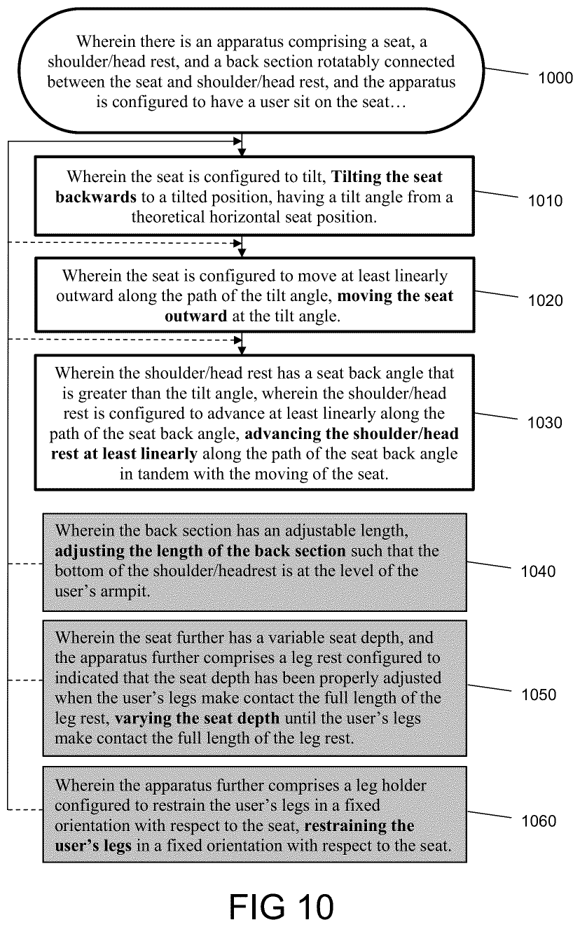

Moving beyond the apparatus to its operation. FIG. 10, shows in simplified form, steps associated with a method of stretching a user's back, comprising:
a starting condition 1000, wherein there is an apparatus comprising a seat, a shoulder/head rest, and a back section rotatably connected between the seat and shoulder/head rest, and the apparatus is configured to allow a user sit on the seat;
a step 1010, wherein the seat is configured to tilt, tilting the seat backwards to a tilted position, having a tilt angle from a theoretical horizontal seat position;
a step 1020, wherein the seat is configured to move at least linearly outward along the path of the tilt angle, moving the seat outward at the tilt angle; and
a step 1030, wherein the shoulder/head rest has a seat back angle that is greater than the tilt angle, wherein the shoulder/head rest is configured to advance at least linearly along the path of the seat back angle, advancing the shoulder/head rest at least linearly along the path of the seat back angle in tandem with the moving of the seat.

Further steps, which are typically, but not limited to, being performed prior to the steps above, comprise one or more of:
a step 1040, wherein the back section has an adjustable length, adjusting the length of the back section such that the bottom of the shoulder/headrest is at the level of the user's armpit.
a step 1050, wherein the seat further has a variable seat depth, and the apparatus further comprises a leg rest configured to indicated that the seat depth has been properly adjusted when the user's legs make contact the full length of the leg rest, varying the seat depth until the user's legs make contact the full length of the leg rest.
a step 1060, wherein the apparatus further comprises a leg holder configured to restrain the user's legs in a fixed orientation with respect to the seat, restraining the user's legs in a fixed orientation with respect to the seat.

Finally, it is to be understood that various different variants of the invention, including representative embodiments and extensions have been presented to assist in understanding the invention. It should be understood that such implementations are not to be considered limitations on either the invention or equivalents except to the extent they are expressly in the claims.

What is claimed:

1. A back stretching apparatus comprising:
a seat;
a shoulder/head rest;
a back section rotatably connected between the seat and shoulder/head rest, wherein the back section has a back length and wherein the back length is fixable;
wherein the seat is configured to at least rotate backwards and to have at least an outward travel away from the shoulder/head rest;
wherein the seat has a horizontal seat position configured to allow a user to sit upon the seat and wherein the seat is further configured to tilt backwards to a tilted position, having a seat-tilt angle with respect to the horizontal seat position;
wherein the seat is further configured to move at least linearly outward along the path of the seat-tilt angle;
wherein the shoulder/head rest has a shoulder/head rest angle with respect to the seat and the shoulder/head rest angle is an angle additional to the seat-tilt angle;
wherein the shoulder/head rest is configured to advance at least linearly along the path of the shoulder/head rest angle; and
wherein, the shoulder/head rest is further configured to move in tandem at least linearly along the path of the shoulder/head rest angle towards the seat when the seat moves at least linearly outward along the path of the seat-tilt angle when the back length has been fixed.

2. The apparatus of claim 1 wherein the back length is adjustable.

3. The apparatus of claim 2 wherein in the back length adjustment is powered and configured to accommodate for the natural lengthen of the user's back due to gravity when reclined.

4. The apparatus of claim 1 further comprises a leg holder configured to restrain a user's legs in a fixed orientation with respect to the seat.

5. The apparatus of claim 4 wherein the fixed orientation with respect to the seat is configured to be settable to within +/−20 degrees of being a right angle.

6. The apparatus of claim 1 wherein the seat is configured to move outward along a curved path to facilitate one of either flexion or hyper extension.

7. The apparatus of claim 1 wherein the seat has a seat depth, and wherein the seat depth is adjustable.

8. The apparatus of claim 7 further comprises a leg rest configured to facilitate seat depth adjustment, wherein the leg rest is configured to indicated that the seat depth has been properly adjusted when the user's legs make contact the full length of the leg rest.

9. The apparatus of claim 1 further comprises a seat angle mechanical stop, which is configured to limit the maximum seat-tilt angle, and a shoulder/head rest mechanical stop, which is configured to decrease the seat tilt angle from the maximum angle once the shoulder/head rest has achieved a specific relationship with respect to being horizontal to the ground.

10. The apparatus of claim 9 wherein the specific relationship with respect to being horizontal to the ground is that the shoulder/head rest is horizontal to the ground.

11. The apparatus of claim 9 wherein the specific relationship with respect to being horizontal to the ground is that the shoulder/head rest set to within 10 degrees above fully horizontal to the ground.

12. The apparatus of claim 9 wherein the specific relationship with respect to being horizontal to the ground is that the shoulder/head rest is set to within 20 degrees above fully horizontal to the ground.

13. A method of stretching a user's back using an apparatus configured to perform the following steps:
wherein the apparatus has a seat, a shoulder/head rest, and a back section rotatably connected between the seat and shoulder/head rest, and configure to allow a user to sit on the seat of the apparatus;
wherein the seat is configured to tilt, tilting the seat backwards to a tilted position, having a tilt angle from a theoretical horizontal seat position;
wherein the seat is configured to move at least linearly outward along the path of the tilt angle, moving the seat outward at the tilt angle; and
wherein the shoulder/head rest has a seat back angle that is greater than the tilt angle, wherein the shoulder/head rest is configured to advance at least linearly along the path of the seat back angle, advancing the shoulder/head rest at least linearly along the path of the seat back angle in tandem with the moving of the seat.

14. The method of claim 13 wherein the back section has an adjustable length, adjusting the length of the back section such that the bottom of the shoulder/headrest 120 is at the level of the user's armpit.

15. The method of claim 13 the seat further has a variable seat depth and the apparatus further comprises a leg rest configured to indicated that the seat depth has been properly adjusted when the user's legs make contact the full length of the leg rest, varying the seat depth until the user's legs make contact the full length of the leg rest.

16. The method of claim 13 wherein the apparatus further comprises a leg holder configured to restrain the user's legs in a fixed orientation with respect to the seat, restraining the user's legs in a fixed orientation with respect to the seat.
